(19) United States
(12) Patent Application Publication
(10) Pub. No.: US 2024/0336726 A1
(43) Pub. Date: Oct. 10, 2024

(54) COPOLYESTER AND FOAM MATERIAL

(71) Applicant: INDUSTRIAL TECHNOLOGY RESEARCH INSTITUTE, Hsinchu (TW)

(72) Inventors: Che-Tseng LIN, Changhua City (TW); Kai-Chuan KUO, Zhushan Township (TW); Jen-Chun CHIU, Zhubei City (TW)

(73) Assignee: INDUSTRIAL TECHNOLOGY RESEARCH INSTITUTE, Hsinchu (TW)

(21) Appl. No.: 18/620,458

(22) Filed: Mar. 28, 2024

(30) Foreign Application Priority Data
Mar. 31, 2023 (TW) 112112445

(51) Int. Cl. C08G 63/183; C08J 9/00

(52) U.S. Cl. CPC C08G 63/183; C08J 9/00; C08J 2367/02

(57) ABSTRACT

A copolyester is formed by reacting 100 parts by weight of a polyester elastomer and 0.01 to 0.29 parts by weight of a compound having multi-functional groups. The polyester elastomer is formed by reacting polyethylene terephthalate, diol, and poly(alkylene ether)glycol. The polyethylene terephthalate and the diol have a weight ratio of 1:0.6 to 1:3, and the polyethylene terephthalate and the poly(alkylene ether) glycol have a weight ratio of 1:0.05 to 1:3.

### CROSS REFERENCE TO RELATED APPLICATIONS

The present application is based on, and claims priority from, Taiwan Application Serial Number 112112445, filed on Mar. 31, 2023, the disclosure of which is hereby incorporated by reference herein in its entirety.

### TECHNICAL FIELD

The technical field relates to a copolyester, and foam material.

### BACKGROUND

The composition of raw materials in traditional sport shoes is complex and contains thermosetting materials, which are difficult to recycle. The waste is ultimately eliminated via incineration, producing carbon emissions. As such, brands have started to redesign products to employ a single-material composition to effectively recycle the waste. The midsole is one of the most important parts of a running shoe. The midsole mainly plays the role of shock absorption, energy feedback, and stability when the sole of the foot hits the ground. The traditional midsole material is EVA based. Due to the development of high-resilience functions and environmental protection issues, TPEE (thermoplastic polyester elastomer) has emerged as an ideal material for several cycles of heavy-use conditions. TPEE has such advantages as good wear resistance, high strength, high toughness, good fatigue resistance, environmental protection, and non-toxicity, and it is recyclable. Compared to traditional EVA midsole components, the foam structure of an elastomer material may be able to provide better elastic feedback and less weight, which is more suitable for use as a midsole component that needs to be flexed repeatedly. Although the properties of TPEE have many advantages, its structure is a linear crystalline polyester, which has a lower melting viscosity and a lower melting strength due to the insufficient degree of entanglement among its molecular chains. When TPEE is processed into foam products, the foam structure will be difficult to maintain, and thus the foam will break. As such, the TPEE chemical structure should be modified to meet the requirements of processing and application.

### SUMMARY

One embodiment of the disclosure provides a copolyester, being formed by reacting 100 parts by weight of a polyester elastomer and 0.01 to 0.29 parts by weight of a compound having multi-functional groups, wherein the polyester elastomer is formed by reacting polyethylene terephthalate, diol, and poly(alkylene ether)glycol, wherein the polyethylene terephthalate and the diol have a weight ratio of 1:0.6 to 1:3, and the polyethylene terephthalate and the poly(alkylene ether)glycol have a weight ratio of 1:0.05 to 1:3, wherein the compound having multi-functional groups includes trimesic acid, 1,1,1-trimethylolpropane, pentaerythritol, sorbitol, or a combination thereof.

One embodiment of the disclosure provides a foam material being manufactured from the described copolyester.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a copolyester being formed by reacting 100 parts by weight of a polyester elastomer and 0.01 to 0.29 parts by weight of a compound having multi-functional groups. If the amount of the compound having multi-functional groups is too high or too low, the copolyester will have a tensile strength that is too low and a tan δ value that is too high. The higher tan δ value of the copolyester means a lower elasticity of the copolyester.

The polyester elastomer is formed by reacting polyethylene terephthalate, diol, and poly(alkylene ether)glycol. For example, the diol serving as a depolymerizer may react with the polyethylene terephthalate, and the depolymerization can be performed at a temperature of 200° C. to 240° C. for a period of 1 hour to 5 hours. The poly(alkylene ether) glycol can be then added to the product of the depolymerization to further react to form the polyester elastomer. The compound having multi-functional groups can be added to the reaction at the same time, such that the polyester elastomer and the compound having multi-functional groups may react to form the copolyester. The reaction for forming the copolyester can be performed at a temperature of 230° C. to 260° C. for a period of 1 hour to 3 hours.

In some embodiments, the polyethylene terephthalate and the diol have a weight ratio of 1:0.6 to 1:3. If the diol amount is too high, it will produce a large amount of byproduct to degrade the physical properties of the copolyester material. If the diol amount is too low, the depolymerization degree of the polyethylene terephthalate will be lowered. The depolymerized polyethylene terephthalate will have a poor reactivity, and be easily phase separated from the poly(alkylene ether)glycol. In some embodiments, the polyethylene terephthalate and the poly(alkylene ether)glycol have a weight ratio of 1:0.05 to 1:3.

In some embodiments, the polyethylene terephthalate has an intrinsic viscosity of 0.55 dL/g to 0.85 dL/g.

In some embodiments, the diol includes linear C₂₋₆ alkylene glycol. In some embodiments, the diol is ethylene glycol, butylene glycol (1,4-butanediol), or a combination thereof.

In some embodiments, the poly(alkylene ether)glycol comprises a polymer of linear C₂₋₄ alkylene glycol, and the poly(alkylene ether)glycol has a number average molecular weight (Mn) of 650 to 2000. For example, the poly(alkylene ether)glycol may include poly(tetramethylene ether)glycol or poly(trimethylene ether)glycol. If the poly(alkylene ether)glycol has an Mn that is too high, it will be easily phase-separated from the PET or PBT segment in the polyester elastomer. The phase separation will easily result in defects in the material. If the poly(alkylene ether)glycol has an Mn that is too low, the polyester elastomer will be too rigid and hard.

In some embodiments, the copolyester is formed by reacting 100 parts by weight of a polyester elastomer and 0.05 to 0.25 parts by weight of a compound having multi-functional groups. In some embodiments, the copolyester is formed by reacting 100 parts by weight of a polyester elastomer and 0.05 to 0.2 parts by weight of a compound having multi-functional groups.

In some embodiments, the compound having multi-functional groups includes trimesic acid, 1,1,1-trimethylolpropane, pentaerythritol, sorbitol, or a combination thereof. Note that not all compounds having multi-functional groups are suitable for reacting with the polyester elastomer to form the copolyester. For example, if glycerol is selected as the compound having multi-functional groups to form the copolyester, in that case, the copolyester will have a tensile strength that is too low and a tan δ value that is too high.

In some embodiments, the copolyester has an intrinsic viscosity of 1.0 dL/g to 3.0 dL/g, such as 1.4 dL/g to 1.6 dL/g.

In some embodiments, the polyethylene terephthalate source can be staple fibers, long fibers, textiles, film materials, or bottle flakes. In some embodiments, the polyethylene terephthalate is a recycled material, a biomass material, a recycled biomass material, or a petrochemical material. In some embodiments, the diol is a recycled material, a biomass material, a recycled biomass material, or a petrochemical material. In some embodiments, the poly(alkylene ether)glycol is a recycled material, a biomass material, a recycled biomass material, or a petrochemical material. It should be understood that the polyethylene terephthalate, the diol, and/or the poly(alkylene ether)glycol is environmentally friendly when it is a recycled material, a biomass material, or a recycled biomass material.

Take polyethylene terephthalate and 1,4-butanediol to perform the depolymerization as an example, the reaction formula is shown below:

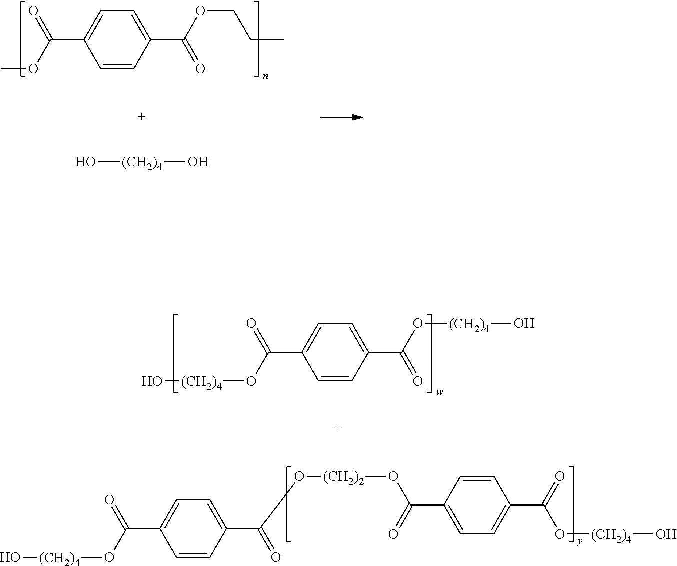

In which n, w, and y are repeating numbers of the repeating units.

The depolymerized product may react with poly(tetramethylene ether)glycol and the compound having multi-functional groups to form the copolyester, and the reaction formula is shown below:

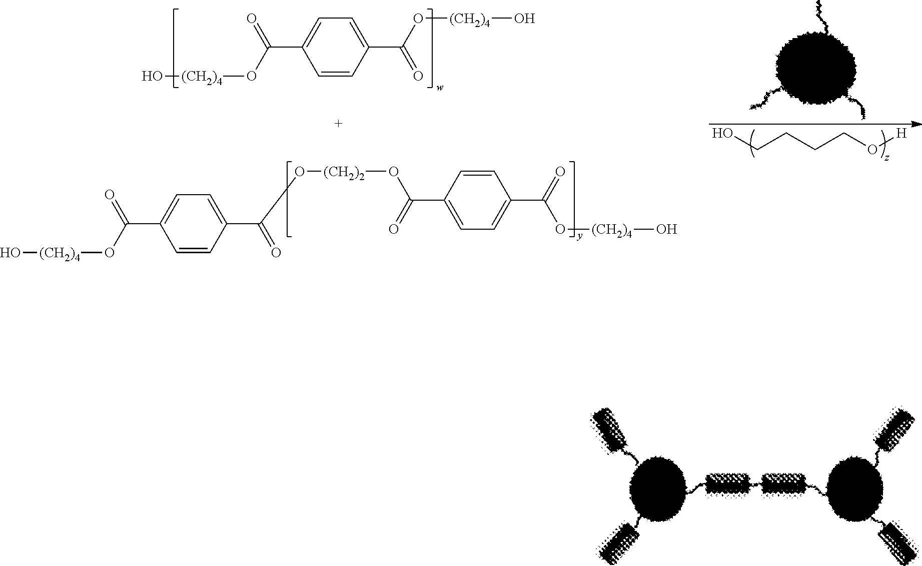

In the above reaction formula, z is the repeating number of the repeating unit of poly(tetramethylene ether)glycol, [symbol] refers to the compound having multi-functional groups, and refers to the polyester elastomer. The polyester elastomer is composed of a hard segment of the repeating unit corresponding to the polybutylene terephthalate (PBT), a soft segment of the repeating unit corresponding to the poly(tetramethylene ether)glycol terephthalate (PTMEGT), and a hard segment of the repeating unit corresponding to polyethylene terephthalate (PET). The chemical structure of the copolymer is shown below:

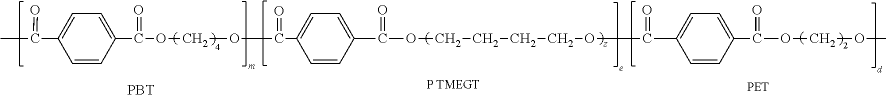

Take polyethylene terephthalate and ethylene glycol to perform the depolymerization as an example, the reaction formula is shown below:

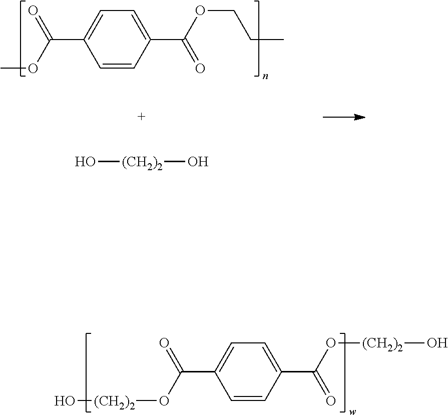

In which n and w are repeating numbers of the repeating units.

The depolymerized product may react with poly(tetramethylene ether)glycol and the compound having multi-functional groups to form the copolyester, and the reaction formula is shown below:

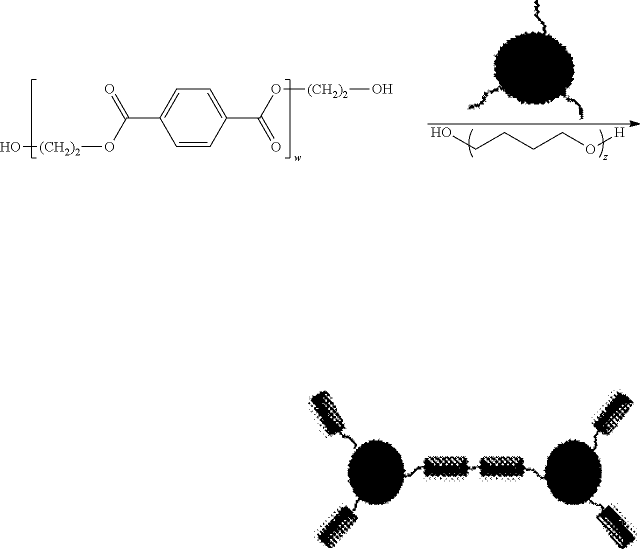

In the above reaction formula, z is the repeating number of the repeating unit of poly(tetramethylene ether)glycol, [symbol] refers to the compound having multi-functional groups, and [symbol] to the polyester elastomer. The polyester elastomer is composed of a soft segment of the repeating unit corresponding to the poly(tetramethylene ether)glycol terephthalate (PTMEGT) and a hard segment of the repeating unit corresponding to polyethylene terephthalate (PET). The chemical structure of the copolymer is shown below:

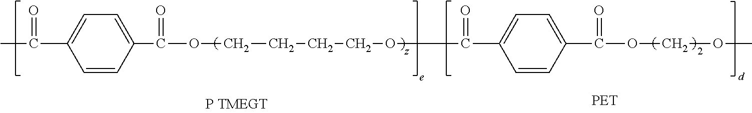

In some embodiments, the copolyester includes a parts by weight of PBT, b parts by weight of PTMEGT, and c parts by weight of PET, a+b+c=100, 0≤a≤90, 10≤b≤80, and 0.1≤c≤90.

One embodiment of the disclosure provides a foam material manufactured from the described copolyester. The method of forming the foam material can be a well-known method in the field, and is not limited to any specific method.

Below, exemplary embodiments are described in detail so as to be easily realized by a person having ordinary knowledge in the art. The inventive concept may be embodied in various forms without being limited to the exemplary embodiments set forth herein.

### Examples

In the following Examples, the recycled polyethylene terephthalate (PET) had an intrinsic viscosity of 0.62 dL/g. Poly(tetramethylene ether)glycol (PTMEG) was commercially available from Methyl Co., Ltd. and had a number average molecular weight (Mn) of 1000. In the following Examples, the properties of the copolyester were measured according to the following standards. Thermal properties such as the melting index (MI) was measured according to the standard ASTM D1238, and the melting point was measured according to the standard ISO 11357-3. Mechanical properties such as tensile strength was measured according to the standard ASTM D412, and the elongation ratio was measured according to the standard ASTM D412. The intrinsic viscosity was measured according to the standard ASTM D446. The viscoelasticity tan δ at 25° C. was measured according to the standard ASTM D5992.

### Example 1

288 g of a recycled PET (RPET), 810 g of 1,4-butanediol (1,4-BDO), and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010 (commercially available from ADVANTAGE INDUSTRIES ENGINEERING CO., LTD.), 0.38 g of the antioxidant CHEMNOX-168 (commercially available from ADVANTAGE INDUSTRIES ENGINEERING CO., LTD.), 0.66 g (0.1 phr) of trimesic acid (TMA), 0.17 g of the catalyst antimony (III) acetate, and 0.76 g of the catalyst titanium butoxide were then added to the reaction tank, and then heated to 255° C. and vacuumed to perform a polymerization reaction for 100 minutes, thereby obtaining a copolyester with an intrinsic viscosity of 1.6 dL/g. The properties of the copolyester were then measured, e.g. the thermal properties such as the melting index (MI, 20 g/10 mins) and the melting point (174° C.), the mechanical properties such as the tensile strength (20.0 MPa) and the elongation ratio (781%), and the viscoelasticity tan δ at 25° C. (0.10). In addition, the NMR spectrum signal integral of the copolyester could be used to calculate the weight ratio of the repeating units of the copolyester. For example, the weight part of the repeating unit corresponding to the polybutylene terephthalate (PBT) (a), the weight part of the repeating unit corresponding to the poly(tetramethylene ether)glycol terephthalate (PTMEGT) (b), and the weight part of the repeating unit corresponding to the polyethylene terephthalate (PET) (c) in the copolyester had a weight ratio (a: b: c) of 35.8:63.6:0.6.

### Example 2

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 0.66 g (0.1 phr) of pentaerythritol, 0.17 g of the catalyst antimony (III) acetate, and 0.76 g of the catalyst titanium butoxide were then added to the reaction tank, and then heated to 255° C. and vacuumed to perform a polymerization reaction for 100 minutes, thereby obtaining a copolyester with an intrinsic viscosity of 1.6 dL/g. The properties of the copolyester were then measured, e.g. the thermal properties such as the melting index (MI, 28 g/10 mins) and the melting point (171.7° C.), the mechanical properties such as the tensile strength (19.0 MPa) and the elongation ratio (792%), and the viscoelasticity tan δ at 25° C. (0.10). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.0:63.4:0.6.

### Example 3

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 0.66 g (0.1 phr) of 1,1,1-trimethylolpropane, 0.17 g of the catalyst antimony (III) acetate, and 0.76 g of the catalyst titanium butoxide were then added to the reaction tank, and then heated to 255° C. and vacuumed to perform a polymerization reaction for 100 minutes, thereby obtaining a copolyester with an intrinsic viscosity of 1.6 dL/g. The properties of the copolyester were then measured, e.g. the thermal properties such as the melting index (MI, 33 g/10 mins) and the melting point (172.9° C.), the mechanical properties such as the tensile strength (18.3 MPa) and the elongation ratio (707%), and the viscoelasticity tan δ at 25° C. (0.10). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.1:63.3:0.6.

### Example 4

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 0.66 g (0.1 phr) of sorbitol, 0.17 g of the catalyst antimony (III) acetate, and 0.76 g of the catalyst titanium butoxide were then added to the reaction tank, and then heated to 255° C. and vacuumed to perform a polymerization reaction for 100 minutes, thereby obtaining a copolyester with an intrinsic viscosity of 1.6 dL/g. The properties of the copolyester were then measured, e.g. the thermal properties such as the melting index (MI, 33 g/10 mins) and the melting point (175.1° C.), the mechanical properties such as the tensile strength (22.1 MPa) and the elongation ratio (779%), and the viscoelasticity tan δ at 25° C. (0.09). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.1:63.3:0.6.

### Example 5

220 g of RPET and 142 g of ethylene glycol (EG) were mixed in a reaction tank, and then heated to 200° C. to react for 1 hour under nitrogen. 220 g of PTMEG, 0.38 g of the antioxidant CHEMNOX-1010, 0.25 g of the antioxidant CHEMNOX-168, 0.44 g (0.1 phr) of pentaerythritol, 0.11 g of the catalyst antimony (III) acetate, and 0.51 g of the catalyst titanium butoxide were then added to the reaction tank, and then heated to 255° C. and vacuumed to perform a polymerization reaction for 90 minutes, thereby obtaining a copolyester with an intrinsic viscosity of 1.6 dL/g. The properties of the copolyester were then measured, e.g. the thermal properties such as the melting index (MI, 33 g/10 mins) and the melting point (199.2° C.), the mechanical properties such as the tensile strength (23 MPa) and the elongation ratio (750%), and the viscoelasticity tan δ at 25° C. (0.08). In addition, the NMR spectrum signal integral of the copolyester could be used to calculate the weight ratio of the repeating units of the copolyester. For example, the weight part of the repeating unit corresponding to PTMEGT (b) and the weight part of the repeating unit corresponding to PET (c) in the copolyester had a weight ratio (b: c) of 63.5:36.5.

### Comparative Example 1

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 0.17 g of the catalyst antimony (III) acetate, and 0.76 g of the catalyst titanium butoxide were then added to the reaction tank, and then heated to 255° C. and vacuumed to perform a polymerization reaction for 125 minutes, thereby obtaining a polyester elastomer with an intrinsic viscosity of 1.4 dL/g. The properties of the polyester elastomer were then measured, e.g. the thermal properties such as the melting index (MI, 51 g/10 mins) and the melting point (175.4° C.), the mechanical properties such as the tensile strength (20.0 MPa) and the elongation ratio (800%), and the viscoelasticity tan δ at 25° C. (0.12). In addition, the NMR spectrum signal integral of the polyester elastomer could be used to calculate the weight ratio of the repeating units of the polyester elastomer. For example, the weight part of the repeating unit corresponding to the PBT (a), the weight part of the repeating unit corresponding to PTMEGT (b), and the weight part of the repeating unit corresponding to PET (c) in the polyester elastomer had a weight ratio (a: b: c) of 36.0:63.4:0.6. As shown in Comparative Example 1, the polyester elastomer that was not reacted with the compound having multi-functional groups had a tan δ value that was too high (i.e. insufficient elasticity).

### Comparative Example 2

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 0.66 g (0.1 phr) of glycerol, 0.17 g of the catalyst antimony (III) acetate, and 0.76 g of the catalyst titanium butoxide were then added to the reaction tank, and then heated to 255° C. and vacuumed to perform a polymerization reaction for 100 minutes, thereby obtaining a copolyester with an intrinsic viscosity of 1.6 dL/g. The properties of the copolyester were then measured, e.g. the thermal properties such as the melting index (MI, 45 g/10 mins) and the melting point (174.6° C.), the mechanical properties such as the tensile strength (17.0 MPa) and the elongation ratio (700%), and the viscoelasticity tan δ at 25° C. (0.12). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 35.8:63.6:0.6. As shown in Comparative Example 2, when the compound having multi-functional groups was glycerol, the copolyester would have a tensile strength that was too low and a tan δ value that was too high.

### Comparative Example 3

192 g of RPET, 270 g of 1,4-BDO, and 0.38 g of the catalyst titanium butoxide were mixed in a reaction tank, and then heated to 220° C. to react for 3 hours under nitrogen. 220 g of PTMEG, 0.38 g of the antioxidant CHEMNOX-1010, 0.25 g of the antioxidant CHEMNOX-168, 0.11 g of the catalyst antimony (III) acetate, and 0.51 g of the catalyst titanium butoxide were then added to the reaction tank, and then heated to 255° C. and vacuumed to perform a polymerization reaction for 120 minutes, thereby obtaining a polyester elastomer. The properties of the polyester elastomer were then measured, e.g. the thermal properties such as the melting index (MI, 55 g/10 mins) and the melting point (168.5° C.), the mechanical properties such as the tensile strength (13.2 MPa) and the elongation ratio (589%), and the viscoelasticity tan δ at 25° C. (0.12). In addition, the NMR spectrum signal integral of the polyester elastomer could be used to calculate the weight ratio of the repeating units of the polyester elastomer. For example, the weight part of the repeating unit corresponding to the PBT (a), the weight part of the repeating unit corresponding to PTMEGT (b), and the weight part of the repeating unit corresponding to PET (c) in the polyester elastomer had a weight ratio (a:b:c) of 27.5:70.7:1.8. As shown in Comparative Example 3, the polyester elastomer that was not reacted with the compound having multi-functional groups had a tensile strength that was too low.

### Comparative Example 4

192 g of RPET, 540 g of 1,4-BDO, and 0.38 g of the catalyst titanium butoxide were mixed in a reaction tank, and then heated to 220° C. to react for 3 hours under nitrogen. 330 g of PTMEG, 0.38 g of the antioxidant CHEMNOX-1010, 0.25 g of the antioxidant CHEMNOX-168, 0.022 g (0.005 phr) of pentaerythritol, 0.11 g of the catalyst antimony (III) acetate, and 0.51 g of the catalyst titanium butoxide were then added to the reaction tank, and then heated to 255° C. and vacuumed to perform a polymerization reaction for 120 minutes, thereby obtaining a copolyester. The properties of the copolyester were then measured, e.g. the thermal properties such as the melting index (MI, 55 g/10 mins) and the melting point (176.1° C.), the mechanical properties such as the tensile strength (15.3 MPa) and the elongation ratio (648%), and the viscoelasticity tan δ at 25° C. (0.12). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.2:63.2:0.6. As shown in Comparative Example 4, when the amount of the compound having multi-functional groups was too low, the copolyester would have a tensile strength that was too low and a tan δ value that was too high.

### Comparative Example 5

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 1.98 g (0.3 phr) of trimesic acid, 0.17 g of the catalyst antimony (III) acetate, and 0.76 g of the catalyst titanium butoxide were then added to the reaction tank, and then heated to 255° C. and vacuumed to perform a polymerization reaction for 80 minutes, thereby obtaining a copolyester. The properties of the copolyester were then measured, e.g. the thermal properties such as the melting index (MI, 17 g/10 mins) and the melting point (173.7° C.), the mechanical properties such as the tensile strength (17.9 MPa) and the elongation ratio (791%), and the viscoelasticity tan δ at 25° C. (0.12). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.2:63.2:0.6. As shown in Comparative Example 5, when the amount of the compound having multi-functional groups was too high, the copolyester would have a tensile strength that was too low and a tan δ value that was too high.

### Comparative Example 6

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 1.98 g (0.3 phr) of pentaerythritol, 0.17 g of the catalyst antimony (III) acetate, and 0.76 g of the catalyst titanium butoxide were then added to the reaction tank, and then heated to 255° C. and vacuumed to perform a polymerization reaction for 80 minutes, thereby obtaining a copolyester. The properties of the copolyester were then measured, e.g. the thermal properties such as the melting index (MI, 27 g/10 mins) and the melting point (169.7° C.), the mechanical properties such as the tensile strength (15.2 MPa) and the elongation ratio (713%), and the viscoelasticity tan δ at 25° C. (0.12). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.1:63.3:0.6. As shown in Comparative Example 6, when the amount of the compound having multi-functional groups was too high, the copolyester would have a tensile strength that was too low and a tan δ value that was too high.

### Comparative Example 7

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG, 0.57 g of the antioxidant CHEMNOX-1010, 0.38 g of the antioxidant CHEMNOX-168, 1.98 g (0.3 phr) of 1,1,1-trimethylolpropane, 0.17 g of the catalyst antimony (III) acetate, and 0.76 g of the catalyst titanium butoxide were then added to the reaction tank, and then heated to 255° C. and vacuumed to perform a polymerization reaction for 80 minutes, thereby obtaining a copolyester. The properties of the copolyester were then measured, e.g. the thermal properties such as the melting index (MI, 16 g/10 mins) and the melting point (167.8° C.), the mechanical properties such as the tensile strength (15.8 MPa) and the elongation ratio (628%), and the viscoelasticity tan δ at 25° C. (0.11). In addition, the NMR spectrum signal integral of the copolyester could be used to calculate the weight ratio of the repeating units of the copolyester. For example, the weight part of the repeating unit corresponding to the PBT (a), the weight part of the repeating unit corresponding to PTMEGT (b), and the weight part of the repeating unit corresponding to PET (c) in the copolyester had a weight ratio (a:b:c) of 36.2:63.2:0.6. As shown in Comparative Example 7, when the amount of the compound having multi-functional groups was too high, the copolyester would have a tensile strength that was too low, the elongation ratio that was too low, and a tan δ value that was too high.

Comparative Example 8 (PTMEG Having an Overly High Number Average Molecular Weight)

288 g of RPET, 810 g of 1,4-BDO, and 0.57 g of the catalyst titanium butoxide were mixed in a reaction tank, and then heated to 220° C. to react for 3 hours under nitrogen. 330 g of PTMEG (Mn=3000, commercially available from YOUNG SUN CHEMTRADE CO., LTD.), 0.57 g of the antioxidant CHEMNOX-1010, 0.38 g of the antioxidant CHEMNOX-168, 0.66 g (0.1 phr) of 1,1,1-trimethylolpropane, 0.17 g of the catalyst antimony (III) acetate, and 0.76 g of the catalyst titanium butoxide were then added to the reaction tank, and then heated to 255° C. and vacuumed to perform a polymerization reaction. After the reaction was completed, phase separation occurred. As shown in Comparative Example 8, when the number average molecular weight of PTMEG was too high, PTMEG would be easily phase separated from PET or PBT segments. The phase separation would result in the defects in the material.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A copolyester, being:
formed by reacting 100 parts by weight of a polyester elastomer and 0.01 to 0.29 parts by weight of a compound having multi-functional groups,
wherein the polyester elastomer is formed by reacting polyethylene terephthalate, diol, and poly(alkylene ether)glycol,
wherein the polyethylene terephthalate and the diol have a weight ratio of 1:0.6 to 1:3, and the polyethylene terephthalate and the poly(alkylene ether) glycol have a weight ratio of 1:0.05 to 1:3,
wherein the compound having multi-functional groups comprises trimesic acid, 1,1,1-trimethylolpropane, pentaerythritol, sorbitol, or a combination thereof.

2. The copolyester as claimed in claim 1, wherein the polyethylene terephthalate has an intrinsic viscosity of 0.55 dL/g to 0.85 dL/g.

3. The copolyester as claimed in claim 1, wherein the diol comprises linear C₂₋₆ alkylene glycol.

4. The copolyester as claimed in claim 1, wherein the poly(alkylene ether) glycol comprises a polymer of linear C₂₋₄ alkylene glycol, and the poly(alkylene ether) glycol has a number average molecular weight of 650 to 2000.

5. The copolyester as claimed in claim 1, wherein the copolyester has an intrinsic viscosity of 1.0 dL/g to 3.0 dL/g.

6. The copolyester as claimed in claim 1, wherein the polyethylene terephthalate is a recycled material, a biomass material, a recycled biomass material, or a petrochemical material.

7. The copolyester as claimed in claim 1, wherein the diol is a recycled material, a biomass material, a recycled biomass material, or a petrochemical material.

8. The copolyester as claimed in claim 1. wherein the poly(alkylene ether) glycol is a recycled material, a biomass material, a recycled biomass material, or a petrochemical material. 9. A foam material, being manufactured from the copolyester as claimed in claim 1.
